(19) United States
(12) Patent Application Publication
(10) Pub. No.: US 2017/0268234 A1
(43) Pub. Date: Sep. 21, 2017

(54) POST-TENSIONING CONCRETE PIPE WRAP WITH PRE-IMPREGNATED FIBERS

(71) Applicant: HawkeyePedershaab Concrete Technologies, Inc., Clayton, MO (US)

(72) Inventor: Claudio SUBACCHI, Mediapolis, IA (US)

(21) Appl. No.: 15/459,421

(22) Filed: Mar. 15, 2017

Related U.S. Application Data
(60) Provisional application No. 62/309,099, filed on Mar. 16, 2016.

(51) Int. Cl. E04C 5/07; E04C 5/08; B29C 70/02; E04C 3/34

(52) U.S. Cl. CPC E04C 5/073; E04C 3/34; E04C 5/08; B29C 70/023; B29K 2709/06

(57) ABSTRACT

Post-tensioning wrap with pre-packed fiber tapes in resin is wrapped under tension around a concrete article. Post-tensioning wrap comprising a plurality of fiber tapes each comprising a plurality of tendons separated by a resin. The post-tensioning wrap is then cured or partially cured so that the post-tensioning wrap forms a single, unitary material around the cylinder that is substantially impermeable.

This application claims priority to U.S. Provisional Application 62/309,099 filed on Mar. 16, 2016 the contents of which are hereby incorporated by reference herein.

### BACKGROUND

Prestressed concrete plays a significant role in many of the building structures in use today. Prominent applications of prestressed concrete include: bridges, building columns, pressure cylinders, liquid storage tanks, and cylinders. Common to each of these applications, is the goal of eliminating tension forces in concrete load-bearing members, since concrete is notably weak in tension, but is strong in compression. In each of these applications, a prestressing force, applied prior to the concrete being loaded through use, is generated by stretching steel reinforcing members or fibers positioned internal to the concrete member. The stretched reinforcing members exert a compressive force on the concrete, which is arranged (in any one of several different ways) to prevent their relaxing.

Prestressing is commonly accomplished in one of two ways: pretensioning or post-tensioning, and may be applied either to pre-cast members manufactured off site, or may be done in the field, at the point of use of the concrete member. In pretensioning, stretched fibers are mechanically bonded to the concrete while the concrete is being cured. In the post-tensioning method, however, reinforcing members are prevented from being bonded to the concrete, thereby allowing the members to be stretched after the concrete is cured. Axially extending fibers are typically encased in sheaths to prevent bonding of the fibers to the concrete. When the concrete has been cured to a predetermined minimum strength, hydraulic jacks tension the fibers by working against the ends of the beam, thereby putting the beam in compression. An alternative technique, not requiring manual stretching of fibers, could provide significant economic and safety-related advantages.

### SUMMARY

A post-tensioning wrap with pre-packed fiber tapes in resin for a concrete article is disclosed. A cylinder or other object is wrapped under tension with a post-tensioning wrap comprising a plurality of fiber tapes each comprising a plurality of tendons separated by a resin. The post-tensioning wrap is then cured or partially cured so that the post-tensioning wrap forms a single, unitary material around the cylinder that is substantially impermeable.

### BRIEF DESCRIPTION OF THE DRAWINGS

FIG. 1 shows an at least partially cured concrete pipe being rotated and wrapped with a post-tensioning wrap in accordance with this disclosure.

FIG. 1A shows a close-up view of the post-tensioning wrap from view A of FIG. 1.

FIG. 2 is one-half of a cross-sectional view of the concrete cylinder wrapped with the post-tensioning wrap.

### DETAILED DESCRIPTION OF THE ILLUSTRATED EMBODIMENT

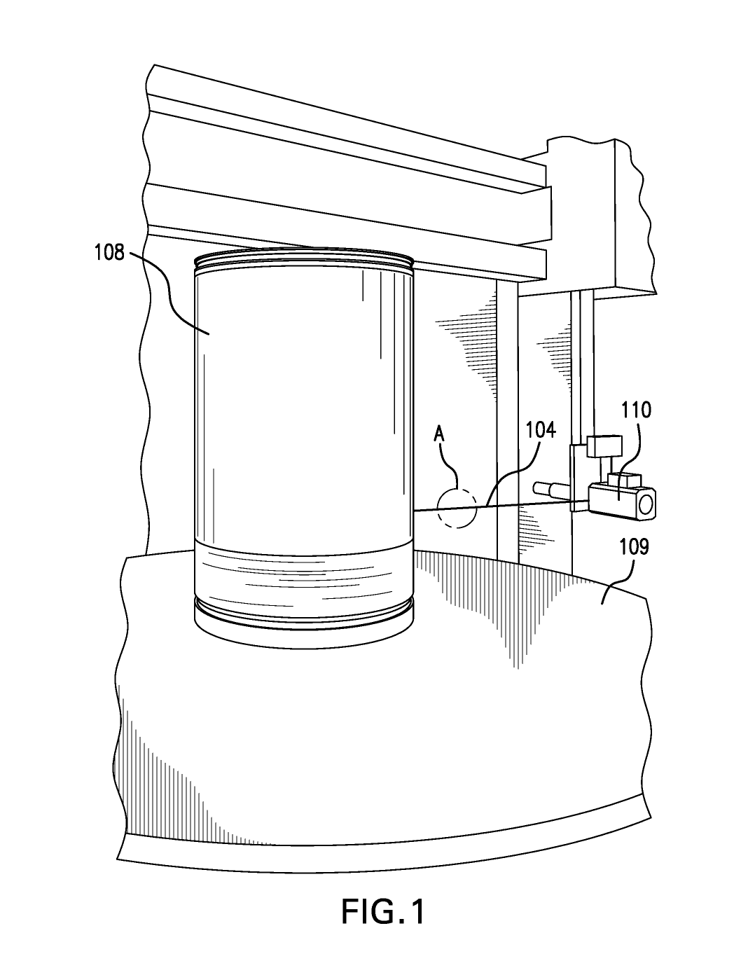

A post-tensioning wrap 100, as shown in FIG. 1A, includes a plurality of fibers tapes 104 bonded together with a resin 105. Post-tensioning wrap 100 can be a combination of fiber tapes 104 or a single fiber tape 104 tow (i.e. a single small tape wound on a spool). Post-tensioning wrap 100 can be spirally or helically wrapped under tension around a concrete cylinder 108, as shown in 1. Post-tensioning wrap 100 can also be wound loosely around cylinder 108 one or more turns without tension, thereafter the friction of post-tensioning wrap 100 winding around on itself is enough for the stressing force.

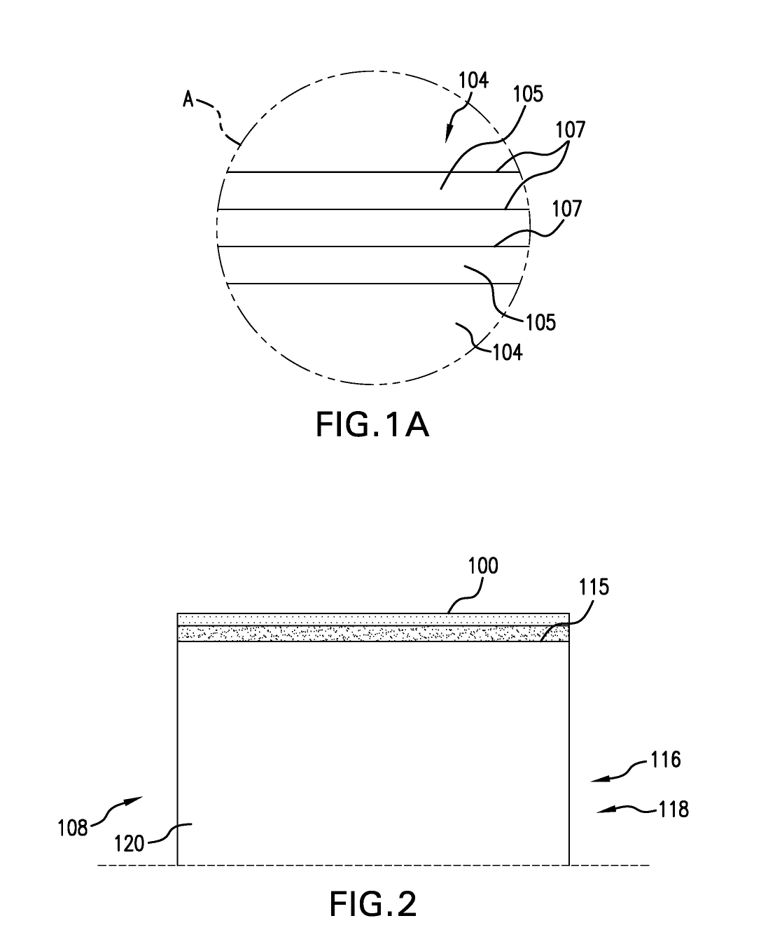

Cylinder 108, as shown in FIG. 2, has a first end 114 and a second end 116 bounded by an external surface 115, and an inner bore 118 defined by an inner wall 120. Cylinder 108 can include interior steel members for reinforcement, but to save cost, the steel reinforcement members can be omitted. Cylinder 108 is fabricated using known techniques, and does not require any special processing, such as pressurizing or otherwise treating the concrete material as it hardens. The present disclosure is not limited to pre-stressing cylinder 108, but encompasses any concrete article that can benefit from pre-stressing, such as culverts of any shape or size, columns, enclosures, tanks, rigid members, etc. Once cylinder 108 is at least partially cured and ready for wrapping it can be placed on a rotating platform 109 for wrapping with post-tensioning wrap 100.

Fiber tapes 104 of post-tensioning wrap 100 can be made of fiberglass, Basalt, or carbon fiber. These types of fiber tapes 104 can maintain high working stresses. Fiberglass or glass fiber tapes 104 can have a tensile strength of 3.3 to 3.5 GPA, Basalt can have a tensile strength of 4 to 4.8 GPA. Carbon fiber can have a tensile strength of 3.6 to 6.2 GPA. High strength steel can have a tensile strength of 1.2 to 1.5 GPA.

Each fiber tape 104 of post-tensioning wrap 100 is made of a plurality of filaments 107 that range from 3 to 20 Microns in size (or any value in between). These filaments 107 can be spirally wound on to a spool 110 to form a single fiber tape 104. Multiple spools 110 can be used to apply at the same time a plurality of fiber tapes 104 to create a wider tape. This post-tensioning wrap 100 in the form of fiber tapes 104 can be wound around cylinder 108 at a helical angle to generate axial compression on cylinder 108. This helical angle can range from 1/10° to 60° (and any value in between). At the end of cylinder 108, these fiber tapes 104 have slightly different areas of coverage around cylinder 108 due to the inversion of the helical angle. The number of fiber tapes 104 and relative layers of post-tensioning wrap 100 around cylinder 108 is related to the working pressure. The amount of stress given to cylinder 108 (and consequently the amount applied to filaments 107 in fiber tapes 104) should be enough to contain the tensile stress in cylinder 108 generated from the internal pressure.

Fiber tapes 104 are impregnated with resin 105 that is partially cured. Partially curing resin 105 causes resin 105 to work as a separator of filaments 107 in fiber tapes 104. The amount of resin between filaments 107 can be minimal. Just enough to separate filaments 107 in fiber tape 104, so that filaments 107 do not rub against each other. Filaments 107 should be close enough together so that they share the tensile stress that is applied during the wrapping process. When a tensile stress is applied to fiber tapes 104, some of filaments 107 may not stretch together. Filaments 107 are highly abrasiveness and, the relative movement between filaments 107 can cause them to break. If, for example, fiber tape 104 is not completely impermeable, this is okay because during the wrapping process some extra resin can also be applied to fiber tape 104 before the fiber is applied to the concrete article. Resin 105 can also be cured when fiber tapes 104 are applied. In this case, when resin 105 is fully cured, additional resin can be added during the wrapping process. In this instance, the amount of resin applied can range from ten to forty percent (10%-40%) of the weight of the filaments 107 in fiber tape 104 and applied at a temperature range of fifteen to one hundred fifty degrees Celsius (15°-150° C.).

Wrapping in this manner allows for a higher tensile stress to the post-tensioning wrap 100 because the partially cured resin significantly improve the load sharing between filaments 107 in fiber tapes 104. Also, fiber tapes 104 with cured resin have a longer shelf life. Also, the added resin that is applied during the wrapping process can be formulated extremely reactive even at ambient temperature so that a heating process for curing the product is not required.

Post-tensioning wrap 100 is wrapped under tension around cylinder 108. The amount of tension depends on the elasticity module of the material in which fibers tapes 104 are made and the characteristics of cylinder 108. For fiber tapes 104 with filaments 107 made of fiberglass, the pre-stressing can be twenty-five to eighty five percent (25%-85%) of the max load of fiber tapes 104, for filaments 107 made of Basalt, the pre-stressing can be twenty-five to eighty percent (25%-85%) of the max load of fiber tapes 104, and for filaments 107 made of carbon fiber the pre-stressing can be twenty-five to eighty percent (25%-85%) of the max load of fiber tapes 104.

Pre-impregnated fiber tapes 104 have several advantages over plain fibers made from other material. The load on cylinder 108 from using a post-tensioning wrap 100 comprising fiber tapes 104 is more evenly distributed than what may be found from using steel fibers because the stressing layer from post-tensioning wrap 100 around cylinder 108 is more continuous. Post-tensioning wrap 100 with steel fibers requires the fibers to be spaced apart in order to have the external protective coating applied to completely surround the steel fibers. In other words, post-tensioning wrap 100 with pre-impregnated fiber tapes 104 are formed of a non-corrosive material so there is no requirement of a further water proof membrane or coating around post-tensioning wrap 100 after it is applied to cylinder 108.

Resin 105 acts as a lubricant for filaments 107. Once resin 105 of post-tensioning wrap 100 is partially cured, fiber tapes 104 can be used as a stressing media with minimal risk of loss of performance and difficulties from further impregnation. Cure times vary depending on material used in resin 105, but generally in the range of twenty to one-hundred and seventh five degrees Celsius (20°-175° C.) for five to one-hundred and twenty minutes (5-125 min) (with any value or range therebetween each of the temperature and time values). Curing time can be extended up to 24 hours. Without pre-impregnating fiber tapes 104, a high stress or load (one that reach a high percentage of the breaking strength) tends to pull filaments 107 and bind them closely together eliminating any room for further impregnating the area between filaments 107 with resin 105. Non-impregnated fiber material has less strength and resiliency, so fibers can tolerate less cycles of loading and unloading. The friction from the filaments or fibers rubbing together will cause an earlier failure.

Another advantage of using pre-impregnated filaments 107 for fiber tapes 104 comes from the final curing of the product. The final curing will happen when the total stressing layer is deposited on the part (e.g. cylinder 108). That means that the final curing will generate a full impermeable, continuous, unitary surface that can actually be a shield to the stressed product (e.g. cylinder 108).

As previously stated, fiber tapes 104 are bonded together in a resin 105. Resin 105 can be an epoxy, polyester, or other plastic resin. Resin 105 is necessary to shield filaments 107 from each other. As it has been discussed, filaments 107 in fiber tapes 104 when wrapped around cylinder 108 under tension would otherwise rub together and abrade to cause degradation and tearing of filaments 107. Resin 105 forms an insular coating around each of filaments 107.

Pressure distributions according to the invention have improved uniformity, and pressure levels are easily controlled and measured, especially when swelling of the outer casing is monitored, as discussed above. It can be seen, therefore, that the prestressed concrete arrangement of the present invention provides uniform pressurizing of the outer surfaces of the prestressed concrete members. Further, the prestressing is accomplished with a single easily fabricated wrap. There is no need to apply a second coat of concrete to protect filaments 107 or fiber tapes 104 of post-tensioning wrap 100 because filaments 107 are protected by resin 105. There is no need to apply tension after post-tensioning wrap 100 is applied with a separate machine, because the post-tensioning is applied during the wrapping process. Finally, the post-tensioning method herein described is easier to carry out with less people resulting in significant time and cost savings.

Post-tensioning wrap 100 can be spirally or helically wrapped around cylinder 108. As stated above, post-tensioning wrap is wrapped under tension as a percentage of the maximum load value of filaments 107 of fiber tapes 104. Post-tensioning wrap 100 is applied over outer surface 115 of cylinder 108. Thereafter, post-tensioning wrap 100 is cured or partially cured, with the ranges and cure times as described above. The curing process transforms post-tensioning wrap 100 into a single continuous, uniform and impermeable barrier around cylinder 108.

The disclosure thus far has focused on applying a post-tensioning wrap 100 around a concrete cylinder 108, wherein cylinder 108 can be existing PCCP pipes (AWWA C301 and/or UNI-EN 64200). The manufacture of such pipes is disclosed, for example, in http://www.forterrapressurepipe.com/pdf/111101-L301-product-sheet815.pdf (online on Mar. 15, 2016) or www.forterrapressurepipe.com/pdf/111102-E301-product-sheet.pdf (online on Mar. 15, 2016), the contents of both of which are hereby incorporated by reference herein. For the C301 L cylinder, post-tensioning wrap 100 is wrapped under tension around the steel can that surrounds a composite concrete-steel core. For the C301 E cylinder, post-tensioning wrap 100 is wrapped under tension on the external concrete layer of the composite concrete-steel-concrete core. In both cases, the resin is cured afterwards.

Post-tensioning wrap 100 can also be used to pre-stress a beam. The benefits of pre-stressing a beam can be found, for example, in Finite Element Analysis of Prestressed Beam, Kote, P. B, JARFSE Vol. 1, Issue 3, August 2014 (found on line at https://www.google.com/search?q=FEA+prestressed+beam&rlz=1C1WPZA_enlT653IT653&espv=2&biw=1920&bih=935&source=lnms&tbm=isch&sa=X&ved=0ahUKEwiP9ObRm8PLAhWJs4MKHcHED-8Q_AUIBigB&dpr=1#imgrc=TfWPPH8gfXPBmM%3A, accessed Mar. 16, 2016), the contents of which are hereby incorporated by reference herein. The prior method included embedding a steel beam in mortar to add the prestress as well as prevent corrosion of the beam. Instead, post-tensioning wrap 100 is substituted for the steel beam and is applied under tension as an external skin to the bottom side of beam at the same stressing level that is applied using regular steel tendons (post-tensioning wrap 100 can also be applied to the top side without tension for the sake of convenience). The top portion of the beam can be encased in concrete in the conventional manner, with the bottom side having post-tensioning wrap 100 wrapped under tension exposed. Once post-tensioning wrap 100 is fully cured, a non-permeable barrier is formed that will protect the beam from any chemicals (e.g. de-icing solutions, etc.) that might be in used.

Reference has been made throughout this disclosure to “one embodiment,” “an embodiment,” or “embodiments” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

While the present invention has been particularly shown and described with reference to exemplary embodiments thereof, it should be understood by those of ordinary skill in the art that various changes, substitutions and alterations could be made herein without departing from the spirit and scope of the invention as embodied by the appended claims and their equivalents.

What is claimed is:

1. A method for stressing an at least partially cured concrete cylinder, the method comprising:
creating a concrete cylinder and allowing the concrete cylinder to at least partially cure;
wrapping under tension the concrete cylinder with a post-tensioning wrap comprising at least one fiber tape comprising a plurality of tendons each of which is separated by a resin that is at least partially cured to prevent the plurality of tendons from rubbing against each other;
at least partially curing the post-tensioning wrap so that the post-tensioning wrap forms a single, unitary material around the concrete cylinder that is substantially impermeable.

2. The method of claim 1, wherein at least partially curing of the post-tension wrap includes heating the post-tensioning wrap at a temperature of twenty to one-hundred and seventy five degrees Celsius for five to one-hundred and twenty minutes.

3. The method of claim 1, wherein wrapping under tension includes tension of 25% to 85% of a max load for a post-tensioning wrap comprising fiber glass fibers.

4. The method of claim 1, wherein wrapping under tension includes 25% to 80% of a max load for a post-tensioning wrap comprising Basalt fibers.

5. The method of claim 1, wherein wrapping under tension includes 25% to 80% of a max load for a post-tensioning wrap comprising carbon fiber fibers.

6. The method of claim 1, wherein a curing time for post-tensioning wrap can be fifteen minutes to twenty four hours (or any number of minutes in between).

7. The method of claim 1, wherein the plurality of fibers of the post-tensioning wrap each comprises of a plurality of filaments.

8. The method of claim 7, wherein the plurality of filaments range from 3 to 20 microns in size.

9. The method of claim 1, and further comprising the curing the resin in the at least one fiber tape before wrapping under tension the concrete cylinder.

10. The method of claim 9, and further comprising adding additional resin to the at least one concrete tape while wrapping under tension the concrete cylinder

11. A concrete cylinder comprising:
a concrete core;
a post-tensioning wrap wrapped around the concrete core; and
the post-tensioning wrap comprising at least one fiber tape comprising a plurality of filaments with each of the plurality of filaments separate by a resin.

12. The concrete cylinder of claim 11, wherein the post-tensioning wrap is applied to the concrete core by rotating the concrete core and allowing the post-tensioning wrap to wrap around the concrete core.

13. The concrete cylinder of claim 12, wherein the post-tensioning wrap comprises a plurality of fiber tapes wrapped around the concrete cylinder substantially simultaneously.

14. The concrete cylinder of claim 13, wherein each of the plurality of filaments range from 3 to 20 microns in size.

15. The concrete cylinder of claim 11, wherein the resin in the post-tensioning wrap is at least partially cured after application to form a single, unitary material around the concrete cylinder that is substantially impermeable.

16. The concrete cylinder of claim 11, wherein the resin in the at least one fiber tape is cured before the at least one fiber tape is wrapped around the concrete core.

17. The concrete cylinder of claim 16, wherein additional resin is applied to the at least one fiber tape as the at least one fiber tape is wrapped around the concrete core.
